(19) United States
(12) Patent Application Publication
(10) Pub. No.: US 2014/0144663 A1
(43) Pub. Date: May 29, 2014

(54) PORTABLE POWER TOOL

(71) Applicant: Robert Bosch GmbH, Stuttgart (DE)

(72) Inventors: Rudolf Fuchs, Neuhausen (DE); Florian Bantle, Gruibingen (DE)

(73) Assignee: Robert Bosch GmbH, Stuttgart (DE)

(21) Appl. No.: 14/076,338

(22) Filed: Nov. 11, 2013

(30) Foreign Application Priority Data
Nov. 28, 2012 (DE) 10 2012 221 748.7

(51) Int. Cl. B25F 5/02

(52) U.S. Cl. CPC B25F 5/02
USPC 173/216; 173/170; 173/217

(57) ABSTRACT

A portable power tool has at least one actuating element and at least one tool holding unit. A center axis of the at least one tool holding unit is configured to extend at least through a vicinity of the at least one actuating element.

This application claims priority under 35 U.S.C. §119 to patent application no. DE 10 2012 221 748.7, filed on Nov. 28, 2012 in Germany, the disclosure of which is incorporated herein by reference in its entirety.

### BACKGROUND

Portable power tools, in particular battery-powered power tools, in which a center axis of a tool holding unit extends through an upper housing, wherein a downwardly protruding handle is fastened to the upper housing, are already known. An actuating element for switching the battery-powered power tool on and off is fastened to the handle.

### SUMMARY

The disclosure proceeds from a portable power tool, in particular a battery-powered power tool, having at least one actuating element and at least one tool holding unit. A “portable power tool” should be understood in particular as meaning a power tool which can be guided with one or both hands of an operator and is different in particular from a stationary power tool. A “battery-powered power tool” should be understood in particular as meaning a portable power tool which is supplied with power by a rechargeable battery and/or battery and is preferably guided with one hand, wherein two-handed guidance may be provided in order to stabilize the battery-powered power tool during use. For example, the battery-powered power tool may be configured as a battery-powered drill, a battery-powered hammer drill, a battery-powered percussion drill, a battery-powered percussion screwdriver or preferably as a battery-powered screwdriver. Preferably, the portable power tool, in particular the battery-powered power tool, is configured in a pistol form. A “pistol form” should be understood in particular as meaning a form of the portable power tool having a handle, in which the portable power tool can be guided with one hand on the handle and the actuating element can be operated with the fingers of a hand grasping the handle, without releasing a grip needed for guiding the portable power tool. An “actuating element” should be understood in particular as meaning an element by means of which function setting of a portable power tool, in particular a battery-powered power tool, can be carried out, in particular switching the portable power tool on or off or setting power values of the portable power tool. Preferably, the actuating element is configured as a pressure switch and particularly preferably as a trigger switch. In principle, the actuating element may also be configured in some other way, for example as a rotary switch or as a touch display. A “trigger switch” should be understood in particular as meaning a switch configured in the form of a trigger, which is actuated with at least one finger and after exceeding a particular pressure threshold, a pressure on the trigger switch effects function setting, wherein, when the pressure threshold is exceeded, the function setting can be configured so as to be variable in a linear manner with changes in pressure. A “tool holding unit” should be understood in particular as meaning a unit of the portable power tool, in particular battery-powered power tool, which is provided to hold and fasten an application tool, for example a bit of a screwdriver or a drill bit. In particular, the tool holding unit has for this purpose an advantageously at least substantially cylindrical holding region for the tool. The tool holding unit is arranged in particular on an upper housing of the portable power tool, in particular of a battery-powered power tool.

It is proposed that a center axis of the tool holding unit extends at least through a vicinity of the actuating element. A “center axis of the tool holding unit” should be understood in particular as meaning an infinitely extending straight line that extends centrally through the holding region for the tool in an orientation direction of a held tool. In particular, the center axis of the tool holding unit corresponds to a force action line of the portable power tool. A “vicinity” should be understood in particular as meaning a region around the actuating element, said region being delimited by a distance of at most 5 mm from the actuating element. As a result of the configuration according to the disclosure of the portable power tool, improved guidance of a portable power tool and improved gripping ergonomics can be achieved in particular.

It is furthermore proposed that the center axis of the tool holding unit extends through the actuating element. Improved guidance of a battery-powered power tool and improved gripping ergonomics can be achieved in particular.

Furthermore, a pistol grip is proposed. A “pistol grip” should be understood in particular as meaning a handle for single-handed guidance of the portable power tool, said handle projecting in an at least substantially perpendicular manner from an upper housing component which has the tool holding unit, wherein an operator can actuate an actuating element of the portable power tool with one or more fingers of a hand with which he grasps the pistol grip in order to guide the portable power tool, without releasing a grip around the pistol grip. The expression “at least substantially perpendicular” should be understood in particular as meaning that an angle between the pistol grip and the upper housing component deviates from 90 degrees by at most 20, advantageously by at most 10 and preferably by at most one degree. In particular, the pistol grip can project from the upper housing component at an angle of 90 degrees. Advantageous gripping ergonomics can be achieved in particular.

It is furthermore proposed that the actuating element is arranged in an actuating finger protective space. An “actuating finger protective space” should be understood in particular as meaning a space which is delimited on at least three sides by a housing of a portable power tool and is provided to receive at least one finger of an operator of the portable power tool and to provide at least one guide region for the finger during actuation of the actuating element, and also preferably to additionally protect the finger from any injuries, in particular on account of pieces of material flying around during use of the portable power tool or on account of the portable power tool slipping. Advantageous guidance and protection of the finger during actuation of the actuating element can be achieved in particular.

It is furthermore proposed that the actuating finger protective space is configured in a closed manner on at least four sides. Preferably, the actuating finger protective space is delimited and closed on one side by a connecting bar. In particular, the side delimited by the connecting bar is formed by a side, located in a ventral direction, of the actuating finger protective space. A “ventral direction” should be understood in particular as meaning a direction extending perpendicularly to the center axis of the tool holding unit, the handle substantially extending in said direction. Advantageous guidance of the finger when resting against the actuating element can be achieved in particular.

It is furthermore proposed that the actuating finger protective space has a height extent of at least 2 cm. A “height extent” of the actuating finger protective space should be understood in particular as meaning an extent of the actuating finger protective space in a direction perpendicular to an actuating direction of the actuating element, a finger width extending in said direction when a finger rests against the actuating element. In particular, the actuating finger protective space has a height extent which allows the actuating element to be actuated with two fingers. Safe guidance of a portable power tool and safe actuation of the actuating element can be achieved in particular.

Furthermore, at least one drive motor is proposed which is arranged at least partially in a region located behind the actuating element, as seen from the tool holding unit. In particular, the drive motor is provided to drive a tool mounted in the tool holding unit. Preferably, the drive motor is formed by an electric motor and particularly preferably by a brushless DC motor (BLDC motor) which is supplied with power in particular by a rechargeable battery of a battery-powered power tool. The fact that the drive motor “is arranged at least partially in a region located behind the actuating element, as seen from the tool holding unit” should be understood in particular as meaning that the drive motor is arranged at least partially in a region of a portable power tool which is located on a projection of the actuating element, said projection extending parallel to the center axis and in a direction away from the tool holding unit. Improved guidance of a portable power tool and improved gripping ergonomics can be achieved in particular.

Furthermore, a handle is proposed, within which the drive motor is at least substantially arranged. The expression “arranged at least substantially within the handle” should be understood in particular as meaning that at least seventy, advantageously at least ninety and particularly preferably one hundred percent of the volume of the drive motor is located within the handle. Preferably, the handle is formed by a pistol grip. On account of the arrangement of the drive motor in the handle, improved guidance of a portable power tool and improved gripping ergonomics can be achieved in particular.

It is furthermore proposed that the center axis of the tool holding unit extends through the drive motor. Improved guidance of a battery-powered power tool and improved gripping ergonomics can be achieved in particular.

Furthermore, at least one connecting drive train unit for transmitting force from the drive motor to the tool holding unit is proposed, wherein the connecting drive train unit is guided past the actuating element and in particular past the actuating finger protective space. A “connecting drive train unit” should be understood in particular as meaning a unit having at least one connecting drive train for force transmission, said connecting drive train being configured in a substantially rod-like manner and being mounted preferably in a rotatable manner, said unit being connected at one end to the drive motor and being driven by the latter, and being connected at another end to the tool holding unit and transmitting a force of the drive motor to the latter. A gear unit may be arranged upstream or downstream of the connecting drive train, in the direction of the flow of force from the drive motor to the tool holding unit, wherein said gear unit is arranged preferably between the connecting drive train and the tool holding unit. The connecting drive train unit transmits in particular forces from the drive motor to the gear unit in order to drive the tool holding unit and/or to drive an application tool held in the tool holding unit. The expression “guided past” should be understood in particular as meaning that, in particular on account of a position of the at least one actuating element on the portable power tool, a path of the force transmission from the drive motor to the tool holding unit turns out longer than a path of the force transmission in the case of a hypothetical course of the connecting drive train unit through the position of the actuating element on the portable power tool, wherein, in the case of the hypothetical course of the connecting drive train unit through the position of the actuating element on the portable power tool, the connecting drive train extends in particular completely within the housing of the portable power tool, apart from a passage through a possible actuating finger protective space. Preferably, the connecting drive train unit is arranged in a manner separated from the actuating element by a housing of the portable power tool. In particular, as viewed in a machining direction, the drive motor is arranged at least partially in front of the actuating element, the gear unit is arranged at least partially behind the actuating element and preferably the actuating element is arranged completely in a region between the drive motor and the actuating element. A “machining direction” should be understood in particular as meaning a direction within the portable power tool along the center axis of the tool holding unit toward the tool holding unit. Preferably, the connecting drive train unit is guided past the actuating element above the latter. The term “above” should be understood in particular as meaning arranged on a side, facing the top side of the portable power tool and remote from the handle, of the actuating element. In principle, the connecting drive train unit can also be guided past the actuating element below the latter, to the left of the latter or to the right of the latter. Preferably, the connecting drive train unit extends at least substantially parallel to the center axis of the tool holding unit and parallel to a longitudinal extent of an actuating finger protective space in which the actuating element is arranged. Preferably, the gear unit and drive motor are arranged such that a shortest connecting line, arranged within the battery-powered power tool, between the gear unit and the drive motor deviates from a straight line. Advantageously space-saving and ergonomically advantageous positioning of the drive motor can be achieved in particular.

Furthermore a gear unit is proposed which is arranged between the connecting drive train unit and the tool holding unit. A “gear unit” should be understood in particular as meaning a unit having at least one gear, for example a planetary gear, wherein the gear unit may have further elements, for example a notched disk, a percussion screw mechanism or a hammer mechanism. The gear unit is provided to adapt a rotational speed of an output drive of the drive motor and/or of the connecting drive train unit to a rotational speed of the application tool and/or of the tool holding unit via a constant and/or variable transmission ratio. A flexible portable power tool can be achieved in particular in a structurally simple manner.

Furthermore, at least one angular gear unit is proposed which connects the connecting drive train unit to the drive motor. An “angular gear unit” should be understood in particular as meaning a gear unit which changes a rotational movement at least in one direction. In particular, the angular gear unit is provided to connect a drive motor, which is arranged in the handle and is oriented at least substantially in a direction perpendicular to the center axis of the tool holding unit, to a connecting drive train unit extending at least substantially parallel to the center axis, and to transmit a rotational movement of the output shaft of the drive motor to the connecting drive train unit. Advantageously space-saving and ergonomic positioning of the drive motor can be achieved in particular in a structurally simple manner.

The portable power tool according to the disclosure is not intended to be limited to the above-described application and embodiment. In particular, the portable power tool according to the disclosure can have a number of individual elements, components and units which differs from the number mentioned herein in order to fulfill a functionality described herein.

### BRIEF DESCRIPTION OF THE DRAWINGS

Further advantages can be gathered from the following description of the drawing. Six exemplary embodiments of the disclosure are illustrated in the drawing. The drawing, the description and the claims contain numerous features in combination. A person skilled in the art will expediently also consider the features individually and combine them to form appropriate further combinations.

In the drawing:

FIG. 1 shows a portable power tool according to the disclosure, configured as a battery-powered power tool, in a pistol form,

FIG. 2 shows an alternative configuration of a portable power tool having a grip protector for the handle,

FIG. 3 shows an alternative configuration of a portable power tool having a drive motor, with an internal fan, arranged in a handle,

FIG. 4 shows a further alternative configuration of a portable power tool having a drive motor, with an internal fan, arranged in a handle,

FIG. 5 shows a further alternative configuration of a portable power tool having a drive motor, with an internal fan, arranged in a handle, and

FIG. 6 shows an alternative configuration of a portable power tool having a drive motor, with an external fan, arranged in a handle.

### DETAILED DESCRIPTION

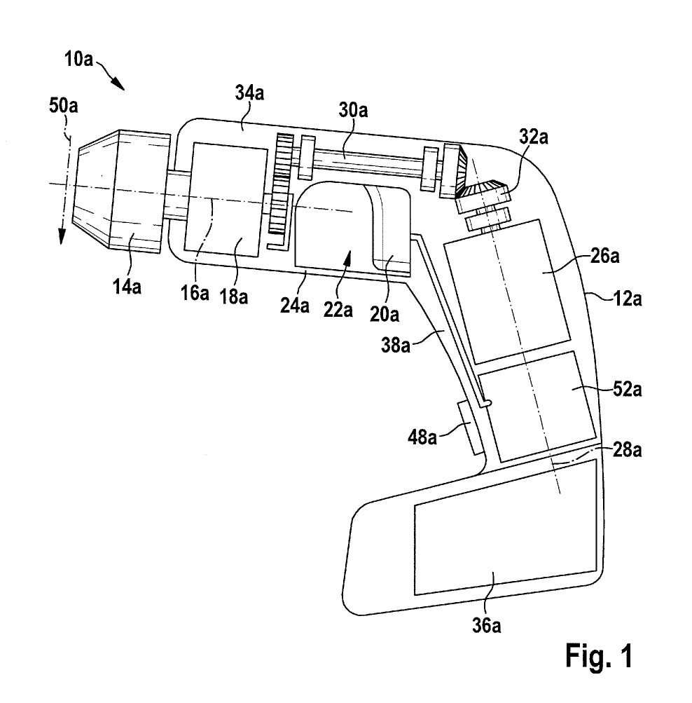

FIG. 1 shows a portable power tool according to the disclosure, which is configured as a battery-powered power tool 10a. The battery-powered power tool 10a is configured as a battery-powered screwdriver. The battery-powered power tool 10a is configured in a pistol form and has a handle 38a by way of which the battery-powered power tool 10a is grasped in order to be used and guided. The battery-powered power tool 10a is intended to be guided in a single-handed manner by grasping the handle 38a, wherein in principle a second hand of an operator can be used to guide the battery-powered power tool 10a, for example in order to grasp an upper housing component 34a. The handle 38a is embodied as a pistol grip 12a. In the example shown, the battery-powered power tool 10a comprises an actuating element 20a and a tool holding unit 14a which is provided to hold a screw for screwing in. A power supply unit 36a formed by a rechargeable battery is arranged in the handle 38a in a lower region which faces the ground during normal operation and faces away from the upper housing component 34a. In alternative configurations, instead of a power supply unit 36a configured as a rechargeable battery, use can be made for example of a power supply unit 36a configured as a battery. The lower region in which the power supply unit 36a is arranged is configured in a manner projecting forward, as seen in a direction toward the tool holder. Arranged on the handle 38a above the projecting, lower region is a further actuating element 48a, which interacts with the actuating element 20a in order to switch on and/or set the battery-powered power tool 10a. In alternative configurations, it is possible to dispense with the further actuating element 48a.

A center axis 16a of the tool holding unit 14a extends through the actuating element 20a and thus through a vicinity of the actuating element 20a. In alternative configurations of the battery-powered power tool 10a, the center axis 16a of the tool holding unit 14a can also extend for example at a distance of 5 mm above an upper end of the actuating element 20a or at a short distance therefrom. The center axis 16a of the tool holding unit 14a is at a distance from a center point of the actuating element 20a and two thirds of a longitudinal extent of the actuating element 20a extend on a side, facing the handle 38a, of the center axis 16a, said side facing the ground during normal operation. The actuating element 20a thus extends largely on a side, facing the handle 38a, of the center axis 16a, said side facing the ground during normal operation. As a result of such a course of the center axis 16a, advantageous ergonomics when the actuating element 20a is actuated and the battery-powered power tool 10a is guided can be achieved, since a force action line of the battery-powered power tool 10a, which extends along the center axis 16a of the tool holding unit 14a, extends through a hand of an operator and beneath at least one actuating finger of the operator, as a result of which undesired torques on the hand can be avoided.

The battery-powered power tool 10a has an actuating finger protective space 22a in which the actuating element 20a is arranged. The center axis 16a of the tool holding unit 14a thus also extends through the actuating finger protective space 22a. The actuating finger protective space 22a is formed in a closed manner on a side extending parallel to the center axis (16a) and facing the handle 38a and is closed there by a connecting bar 24a between two subregions of the upper housing component 34a. The connecting bar 24a is arranged on a side of the center axis 16a of the tool holding unit 14a, which side faces the ground in a normal operating state, and provides a bearing surface for an actuating finger of the operator and protection against any sharp edges or splinters in an environment. The actuating finger protective space 22a has a height extent of 5 cm, as a result of which actuation of the actuating element 20a by means of two fingers is possible. The height extent is formed by an extent of the actuating finger protective space 22a perpendicular to a longitudinal extent of the actuating finger protective space 22a and extending in a substantially perpendicular manner to the center axis 16a of the tool holding unit 14a, said extent of the actuating finger protective space 22a extending parallel to a surface normal of the ground in a normal operating state of the battery-powered power tool 10a. In principle, the actuating finger protective space 22a can have a smaller height extent in alternative configurations, such that the actuating element 20a can be actuated only with one actuating finger.

The battery-powered power tool 10a comprises a drive motor 26a which is arranged at least partially in a region located behind the actuating element 20a as seen from the tool holding unit 14a. In the case of a projection of the actuating element 20a in a direction leading away from the tool holding unit 14a and extending parallel to the center axis 16a, approximately half of the drive motor 26a is located within a region intersected by the projection and a further half extends downward, i.e. in a direction toward the ground in a normal operating state, in the direction of the handle 38a. The drive motor 26a is arranged within the handle 38a. The center axis 16a of the tool holding unit 14a extends through the drive motor 26a and passes through the latter in an upper region facing a top side of the battery-powered power tool 10a. The top side of the battery-powered power tool 10a is arranged opposite the handle 38a and in a manner facing away from the handle 38a. A motor axis 28a of the drive motor 26a encloses an angle of 70 degrees with the center axis 16a of the tool holding unit 14a.

The battery-powered power tool 10a furthermore has a connecting drive train unit 30a for transmitting force from the drive motor 26a to the tool holding unit 14a, said connecting drive train unit 30a extending substantially to the side of the actuating finger protective space 22a. The connecting drive train unit 30a has a rotatably mounted connecting drive train which is connected at one end to a gear and at a further end has a rotating disk having a beveled surface which meshes with a similarly configured rotating disk having a beveled surface of an output shaft of the drive motor 26a. The rotating disks form an angular gear unit 32a of the battery-powered power tool 10a, which connects the connecting drive train unit 30a to the drive motor 26a. A gear unit 18a connects the connecting drive train unit 30a to the tool holding unit 14a and is provided to adapt a rotational speed of the output shaft of the drive motor 26a to a provided rotational speed of the tool holding unit 14a by means of a constant and/or variable transmission ratio. The gear unit 18a may be configured for example as a planetary gear, wherein the connecting drive train unit 30a drives for example a sun gear or planet gear, an internal gear or a planet carrier. In alternative configurations, the battery-powered power tool 10a may be configured for example as a battery-powered percussion screwdriver or as a battery-powered percussion drill and the gear unit 18a may to this end comprise for example instead of or in addition to a screwdriver gear, a gear having a percussion screw mechanism, a gear having a notched disk for percussion drilling or a gear having a hammer mechanism.

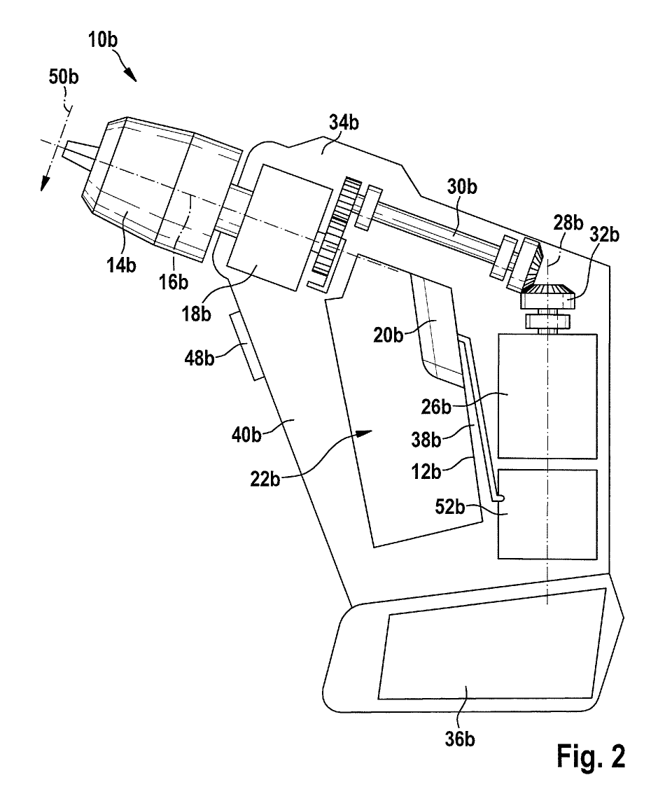

FIGS. 2 to 6 show five further exemplary embodiments of the disclosure. The following descriptions and the drawings are limited substantially to the differences between the exemplary embodiments, with reference being made in principle also to the drawings and/or the description of the other exemplary embodiments, in particular FIG. 1, with regard to identically designated components, in particular with regard to components having identical reference signs. In order to distinguish between the exemplary embodiments, the letter a is positioned after the reference signs of the exemplary embodiment in FIG. 1. In the exemplary embodiments in FIGS. 2 to 6, the letter a is replaced by the letters b to f.

The alternative embodiment of a battery-powered power tool 10b in FIG. 2 is substantially identical to the previous exemplary embodiment and differs therefrom only by an additional grip protection element 40b which extends from the upper housing component 34b in a normal operating state facing the ground and is arranged, in a viewing direction through the upper housing component 34b along a center axis 16b toward a tool holding unit 14b, behind a handle 38b configured as a pistol grip 12b. The grip protection element 40b is provided to afford additional protection to a hand of an operator who is grasping the handle 38b when guiding the battery-powered power tool 10b. A further actuating element 48b for actuating the battery-powered power tool 10b is arranged on the grip protection element 40b.

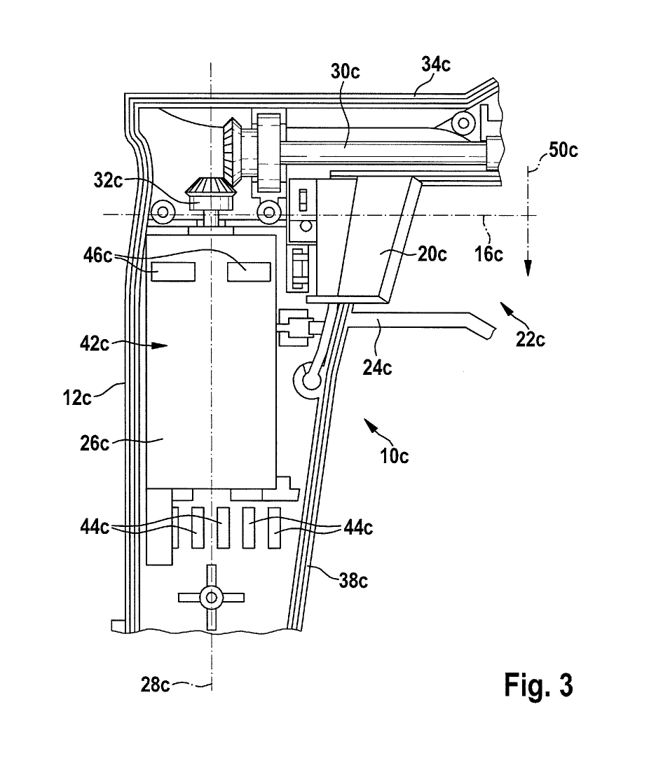

FIG. 3 shows a detail of an alternative battery-powered power tool 10c, which is configured as a battery-powered screwdriver and is constructed in a manner substantially similar to the preceding exemplary embodiments. A center axis 16c of a tool holding unit (not illustrated in the detail shown) extends through a vicinity of and in particular directly through an actuating element 20c which is arranged in an actuating finger protective space 22c. The battery-powered power tool 10c comprises a handle 38c configured as a pistol grip 12c, within which a drive motor 26c is arranged, and an upper housing component 34c in which the actuating finger protective space 22c is arranged. The actuating finger protective space 22c is configured in a downwardly closed manner, i.e. on a side extending parallel to the center axis 16c and facing the handle 38c, by a connecting bar 24c. The drive motor 26c has a diameter of 28 mm and a length of 54 mm which is more than one and a half times the size of the diameter. The drive motor 26c is configured as what is known as a brushless DC motor, i.e. as a DC motor having an electronic circuit which replaces a mechanical commutator, otherwise necessary in DC motors, having brushes for reversing current in order to generate a rotating magnetic field from a direct current. The battery-powered power tool 10c furthermore comprises a fan unit 42c which is provided for ventilating and cooling the drive motor 26c and is integrated in the drive motor 26c. The fan unit 42c draws in air from a space outside the battery-powered power tool 10c via air passage openings 44c arranged on the handle 38c in a region beneath the drive motor 26c, i.e. on a side, facing away from the upper housing component 34c, of the drive motor 26c, in order to cool the drive motor 26c. Heated exhaust air is blown out through further air passage openings 46c which are arranged radially on an upper region of the drive motor 26c. The fan unit 42c is thus arranged partially in an upper region of the drive motor 26c. In principle, in an alternative configuration, air can also be drawn in via the further air passage openings 46c and blown out via the air passage openings 44c. The drive motor 26c is cooled from the inside by the integrated fan unit 42c. An angular gear unit 32c connects the drive motor 26c to a connecting drive train unit 30c and deflects a force flow from a direction of a motor axis 28c of the drive motor 26c, said axis extending perpendicularly to the center axis 16c, into a direction extending parallel to the center axis 16c of the connecting drive train unit 30c. In principle, the motor axis 28c can also include an angle not equal to 90 degrees with the center axis 16c.

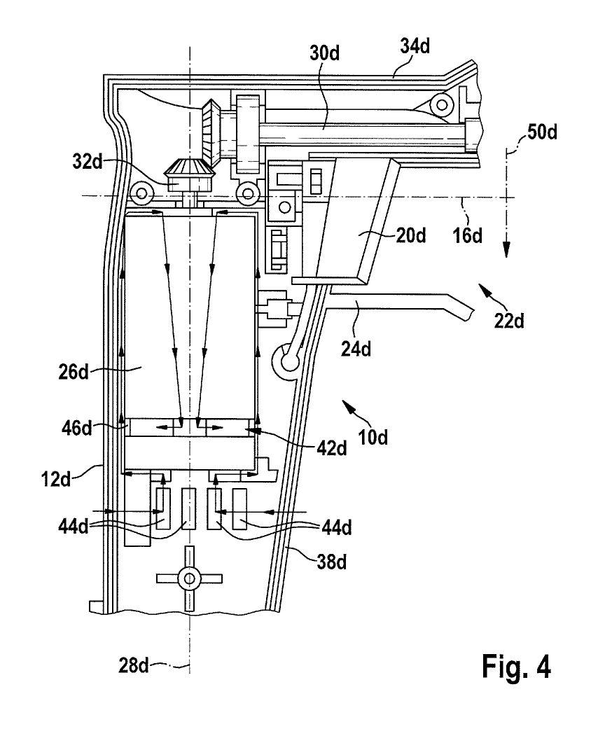

In a further alternative embodiment (FIG. 4) of a battery-powered power tool 10d, the latter is configured in a manner substantially similar to the previous exemplary embodiment with an upper housing component 34d and a handle 38d configured as a pistol grip 12d. Arranged in the handle 38d is a drive motor 26d which is connected by means of an angular gear unit 32d to a connecting drive train unit 30d in the upper housing component 34d, wherein the angular gear unit 32d deflects a force flow from a direction of a motor axis 28d, said axis extending perpendicularly to a center axis 16d, into a direction of the connecting drive train unit 30d which extends parallel to the center axis 16d. In principle, the motor axis 28d can also include an angle not equal to 90 degrees with the center axis 16d. The connecting drive train unit 30d is guided past an actuating element 20d which is arranged in an actuating finger protective space 22d in the upper housing component 34d. The drive motor 26d has a diameter of 28 mm and a length of 54 mm which is more than one and a half times the size of the diameter. The drive motor 26d is configured as a brushless DC motor, i.e. as a DC motor having an electronic circuit which replaces a mechanical commutator, otherwise necessary in DC motors, having brushes for reversing current in order to generate a rotating magnetic field from a direct current. The battery-powered power tool 10d furthermore comprises a fan unit 42d which is provided for ventilating and cooling the drive motor 26d and is integrated in the drive motor 26d. The fan unit 42d is arranged in a lower region of the drive motor 26d and draws in air from a space outside the battery-powered power tool 10d via air passage openings 44d arranged on the handle 38d in a region beneath the drive motor 26d, i.e. on a side, facing away from the upper housing component 34d, of the drive motor 26d, in order to cool the drive motor 26d. Heated air is blown out via further air passage openings 46d arranged radially on the drive motor 26d in a lower region. In principle, in an alternative configuration, air can also be drawn in via the further air passage openings 46d and blown out via the air passage openings 44d. The air drawn in through the air passage openings 44d flows past the outside of the drive motor 26d and thus cools it from the outside and is guided from above, i.e. from a side facing the upper housing component 34d, through the drive motor 26d by the fan unit 42d for the purpose of cooling from the inside, before it is blown out through the air passage openings 46d. The drive motor 26d is thus cooled from the inside and the outside. The air passage openings 44d, 46d are arranged at a suitable distance from the actuating element 20d such that they are not covered by a hand of an operator when the battery-powered power tool 10d is guided in a single-handed manner as intended.

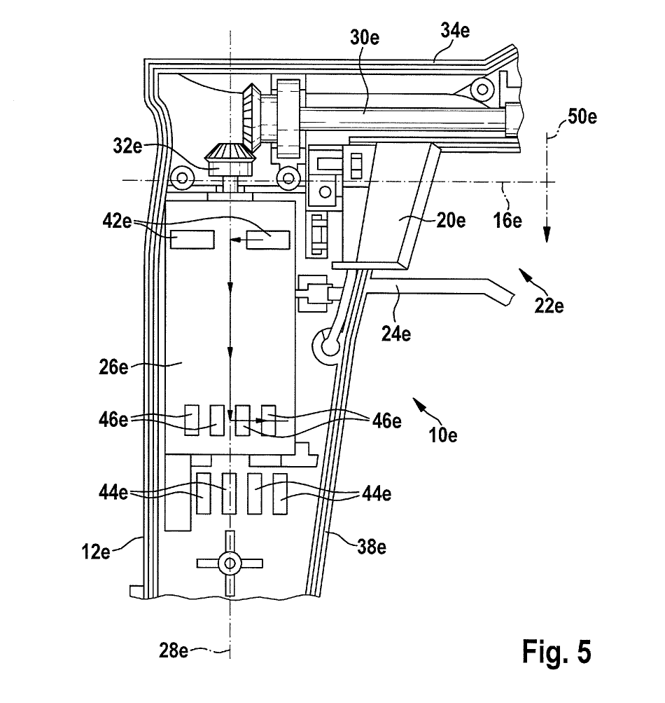

A further alternative embodiment (FIG. 5) of a battery-powered power tool 10e is configured in a manner substantially similar to the previous exemplary embodiment. A fan unit 42e for ventilating and cooling a drive motor 26e arranged in a handle 38e configured as a pistol grip 12e is integrated in the drive motor 26e and arranged in an upper region of the drive motor 26e. The fan unit 42e has an air passage opening 44f which is arranged above the drive motor 26f and draws in air from a space outside a battery-powered power tool 10e via air passage openings 44e arranged on the handle 38e in a region beneath the drive motor 26e, i.e. on a side, facing away from an upper housing component 34e, of the drive motor 26e, in order to cool the drive motor 26e. Heated air is blown out via further air passage openings 46e arranged radially on the drive motor 26e in a lower region. In principle, in an alternative configuration, air can also be drawn in via the further air passage openings 46e and blown out via the air passage openings 44e. The air drawn in through the air passage openings 44e flows past the outside of the drive motor 26e and thus cools it from the outside and is guided from above, i.e. from a side facing the upper housing component 34e, through the drive motor 26e by the fan unit 42e for the purpose of cooling from the inside, before it is blown out through the air passage openings 46e. The drive motor 26e is thus cooled from the inside and the outside. The air passage openings 44e, 46e are arranged at a suitable distance from the actuating element 20e such that they are not covered by a hand of an operator when a battery-powered power tool 10e is guided in a single-handed manner as intended.

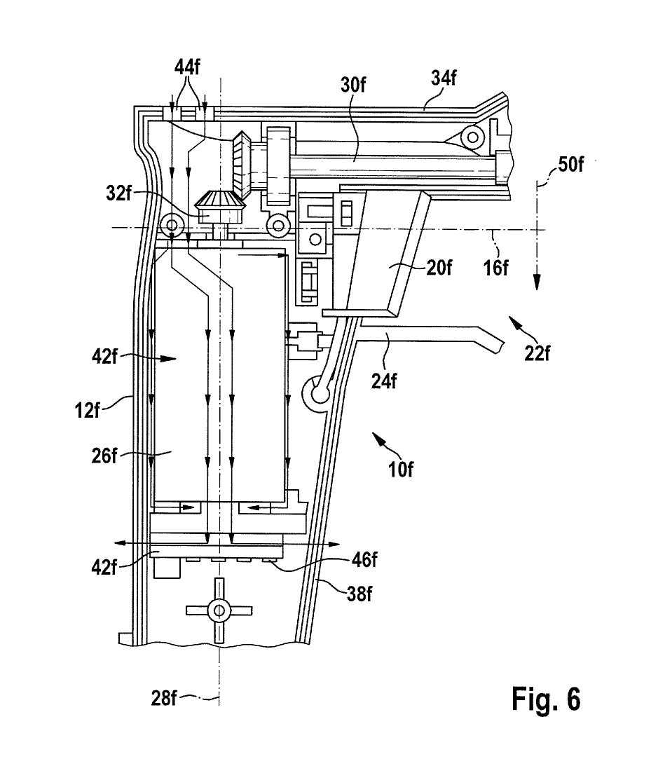

In a further alternative embodiment (FIG. 6) of a battery-powered power tool 10f, a fan unit 42f for a drive motor 26f arranged in a handle 38f configured as a pistol grip 12f is arranged outside the drive motor 26f. The fan unit 42f is arranged beneath the drive motor 26f, i.e. in a region of the handle 38f, seen from which the drive motor 26f is located between the region and the upper housing component 34f. The fan unit 42f draws in air from a space outside a battery-powered power tool 10f via air passage openings 44f arranged on the handle 38f in a region beneath the drive motor 26f, i.e. on a side, facing away from an upper housing component 34f, of the drive motor 26f, in order to cool the drive motor 26f. Heated air is blown out via further air passage openings 46f arranged radially on the drive motor 26f in a lower region. In principle, in an alternative configuration, air can also be drawn in via the further air passage openings 46f and blown out via the air passage openings 44f. The air drawn in through the air passage openings 44f flows past the outside of the drive motor 26f and thus cools it from the outside and is guided from above, i.e. from a side facing the upper housing component 34f, through the drive motor 26f by the fan unit 42f for the purpose of cooling from the inside, before it is blown out through the air passage openings 46f. The drive motor 26f is thus cooled from the inside and the outside. The air passage openings 44f, 46f are arranged at a suitable distance from the actuating element 20f such that they are not covered by a hand of an operator when a battery-powered power tool 10f is guided in a single-handed manner as intended.

What is claimed is:

1. A portable power tool, comprising:
at least one actuating element; and
at least one tool holding unit defining a center axis,
wherein the at least one tool holding unit is configured so that the center axis extends at least through a vicinity of the at least one actuating element.

2. The portable power tool according to claim 1, wherein the at least one tool holding unit is configured so that the center axis extends through the at least one actuating element.

3. The portable power tool according to claim 1, further comprising a pistol grip.

4. The portable power tool according to claim 1, further comprising:
an actuating finger protective space,
wherein the at least one actuating element is arranged in the actuating finger protective space.

5. The portable power tool according to claim 4, wherein the actuating finger protective space is configured in a closed manner on at least four sides.

6. The portable power tool according to claim 4, wherein the actuating finger protective space has a height extent of at least 2 cm.

7. The portable power tool according to claim 1, further comprising:
at least one drive motor arranged at least partially in a region located behind the at least one actuating element, as seen from the at least one tool holding unit.

8. The portable power tool according to claim 7, further comprising a handle, wherein the at least one drive motor is at least substantially arranged within the handle.

9. The portable power tool according to claim 7, wherein the at least one tool holding unit is configured so that the center axis extends through the at least one drive motor.

10. The portable power tool according to claim 7, further comprising:
at least one connecting drive train unit configured to transmit force from the at least one drive motor to the at least one tool holding unit,
wherein the at least one connecting drive train unit is guided past the at least one actuating element.

11. The portable power tool according to claim 10, further comprising a gear unit arranged between the at least one connecting drive train unit and the at least one tool holding unit.

12. The portable power tool according to claim 10, further comprising at least one angular gear unit configured to connect the at least one connecting drive train unit to the at least one drive motor.
